(19) United States
(12) Patent Application Publication
(10) Pub. No.: US 2019/0171701 A1
(43) Pub. Date: Jun. 6, 2019

(54) SYSTEM TO INTEGRATE INTERACTIVE CONTENT, INTERACTIVE FUNCTIONS AND E-COMMERCE FEATURES IN MULTIMEDIA CONTENT

(71) Applicant: Orson Tormey, Highland Park (AU)

(72) Inventor: Orson Tormey, Bangkok (TH)

(73) Assignee: Orson Tormey, Highland Park (AU)

(21) Appl. No.: 16/108,102

(22) Filed: Aug. 22, 2018

Related U.S. Application Data
(60) Provisional application No. 62/524,539, filed on Jun. 25, 2017.

(51) Int. Cl. G06F 17/24; G06T 11/60; G06Q 30/06

(52) U.S. Cl. CPC G06F 17/24; G06F 3/0481; G06Q 30/0641; G06T 11/60

(57) ABSTRACT

Disclosed is a system and method for integrating interactive content, interactive functions and e-commerce features in graphical image files. The method comprises the step of importing images file from graphics applications through an import module. Then the method receives the imported image files comprise a hotspot graphic through an editor module. Then the method feeds a textual data corresponding to the image file through a text module. The method then imports a local image corresponding to the image file through an image module. Then the method appends multiple choice questions and importing answer images through a query module. The method imports an audio file through an audio module. The method then includes the step of appending web link, pop-up link, conditional link, and share link through a link module. The method appends payment receiving information corresponding to one or more items through a payment module.

### FIELD OF INVENTION

The present invention relates to an integrated platform for creating interactive multimedia content, in particular to system and method for integrating a plurality of interactive content, a plurality of interactive functions and a plurality of e-commerce features in multimedia content such as graphical image files.

### BACKGROUND

Typically, interactive multimedia content is a better way to educate, entertain, and engage the audience. Further, rapid improvements in the digital world have changed the way of distribution and monetization of the multimedia content. The multimedia content in the form of learning modules, books, journals, magazines, informative slides or blogs is one of the most valuable assets for the of the digital content providers. The popularity of the internet and the use of computing devices have further increased the demand for digital content.

Generally, the multimedia or digital content providers face various challenges to access control, distribute and monetize their multimedia content while keeping abreast with the new business models to generate profit. Further, the existing systems and methods are either passive or are building interactive content or elements within the visual boundaries of the original content such as annotations or titles directly on multimedia content such as graphical image files which lead to crowded and visually confused multimedia content. Also, the editing process to integrate the multimedia content into an image or video requires substantial training of a user and time to complete. Additionally, the sharing procedure of the selected content on social media or to embed it in a website is cumbersome for the user. Furthermore, the existing systems and fail to adequately provide an easy way to incorporate e-commerce features for the purchase of additional multimedia content, which can appeal to the consumer who requires further instruction or information.

Therefore, there is a need for an efficient and effective system and method to integrate a plurality of interactive content, interactive functions, and e-commerce features into multimedia content such as graphical image files. Further, there is also a need for a system and method to provide an integrated platform to the digital content providers to stay up to speed with the advancing digital content market by utilizing social media marketing strategies to increase the revenue, customer and subscriber base.

Further limitations and disadvantages of conventional and traditional approaches will become apparent to one of skill in the art, through comparison of described systems with some aspects of the present disclosure, as set forth in the remainder of the present application and with reference to the drawings.

### SUMMARY

The present invention mainly solves the technical problems existing in the prior art. In response to these problems, the present invention provides a system and method for integrating a plurality of interactive content, a plurality of interactive functions and a plurality of e-commerce features in a plurality of graphical image files.

An aspect of the present disclosure relates to a device in a network. The device includes a non-transitory storage device and one or more processors. The non-transitory storage device having embodied therein one or more routines operable to integrate a plurality of interactive content, a plurality of interactive functions and a plurality of e-commerce features in a plurality of graphical image files. The one or more processors coupled to the non-transitory storage device and operable to execute the one or more routines. The one or more routines include an import module, an editor module, a hotspot type module, an access module, and a reward module. The hotspot type module comprises a text module, an image module, a query module, an audio module, a link module, and a payment module.

The import module imports a plurality of images file from a plurality of graphics applications. The editor module receives the imported image files. The image file comprises a hotspot graphic adaptable to receive a stretch command, a move command and a rotate command from a user. The hotspot type module pops-up on receiving a click gesture from a user. The hotspot type module enables a user to append the plurality of interactive content, interactive functions, and e-commerce features into the imported image file to obtain the graphical image file.

The text module is configured to enable the user to feed a textual data corresponding to the image file. The graphical image file displays the textual data fed into the text module on receiving an interacting gesture from the user. The image module to import a local image from a plurality of locations corresponding to the image file. The graphical image file displays the local image imported by the image module on receiving the interacting gesture from the user. The query module enables the user to append a plurality of multiple choice questions and further enables the user to import a plurality of answer images. The graphical image file displays the appended multiple choice questions and answer images on receiving the interacting gesture from the user. The audio module enables the user to import an audio file, and further enables the user to record the audio file or convert textual information into the audio file. The graphical image file plays the audio file upon receiving the interacting gesture from the user.

The link module enables the user to append at least one of a web link, a pop-up link, a conditional link, and a share link. The payment module enables the user to append a plurality of payment receiving information corresponding to one or more items. The access module allows the user to access the interactive content on detecting a completion of a plurality of predefined parameters. The reward module provides the user with one or more rewards on detecting a completion of a plurality of predefined criteria.

In an aspect, the web link redirects the user to a website appended by the user.

In an aspect, the pop-up link displays a pop-up window having a predefined multimedia content.

In an aspect, the conditional link redirects to a predefined link on detecting a completion of a plurality of predefined conditions.

In an aspect, the share link displays a plurality of social media icons in a pop-up window above the graphical image file.

An aspect of the present disclosure relates to a method for integrating interactive content, interactive functions and e-commerce features in a plurality of graphical image files. The method comprises a step of importing a plurality of images file from a plurality of graphics applications through an import module. The method then includes the step of receiving the imported image files through an editor module. The image file comprises a hotspot graphic adaptable to receive a stretch command, a move command and a rotate command from a user. Further, the method includes the step of popping a hotspot type module on receiving a click gesture from a user. The hotspot type module enables a user to append the plurality of interactive content, interactive functions, and e-commerce features into the imported image file to obtain the graphical image file.

Then the method includes the step of feeding a textual data corresponding to the image file through a text module configured in the hotspot type module. The graphical image file displays the textual data fed into the text module on receiving an interacting gesture from the user. The method then includes the step of importing a local image from a plurality of locations corresponding to the image file through an image module configured in the hotspot type module. The graphical image file displays the local image imported by the image module on receiving the interacting gesture from the user. Then the method includes the step of appending a plurality of multiple choice questions and further enabling the user to import a plurality of answer images through a query module configured in the hotspot type module. The graphical image file displays the appended multiple choice questions and answer images on receiving the interacting gesture from the user.

Furthermore, the method includes the step of importing an audio file and further enabling the user to record the audio file or convert textual information into the audio file through an audio module configured in the hotspot type module. The graphical image file plays the audio file upon receiving the interacting gesture from the user. The method then includes the step of appending at least one of a web link, a pop-up link, a conditional link, and a share link through a link module configured in the hotspot type module. The method then includes the step of appending a plurality of payment receiving information corresponding to one or more items through a payment module configured in the hotspot type module. The method further comprises a step of allowing the user to access the interactive content on detecting a completion of a plurality of predefined parameters through an access module. The method then comprises a step of providing the user with one or more rewards on detecting a completion of a plurality of predefined criteria through a reward module.

An aspect of the present disclosure relates to a system to integrate a plurality of interactive content, a plurality of interactive functions and a plurality of e-commerce features in a plurality of graphical image files. The system includes a processor and a memory. The memory stores machine-readable instructions that when executed by the processor cause the processor to import a plurality of images file from a plurality of graphics applications through an import module. The processor is then configured to receive the imported image files through an editor module. The image file comprises a hotspot graphic adaptable to receive a stretch command, a move command and a rotate command from a user. Further, the processor is configured to pop-up a hotspot type module on receiving a click gesture from a user. The hotspot type module enables a user to append the plurality of interactive content, interactive functions, and e-commerce features into the imported image file to obtain the graphical image file. The processor is further configured to feed a textual data corresponding to the image file through a text module. The graphical image file displays the textual data fed into the text module on receiving an interacting gesture from the user.

Further, the processor is configured to import a local image from a plurality of locations corresponding to the image file through an image module. The graphical image file displays the local image imported by the image module on receiving the interacting gesture from the user. Then the processor is configured to append a plurality of multiple choice questions and further enables the user to import a plurality of answer images through a query module. The graphical image file displays the appended multiple choice questions and answer images on receiving the interacting gesture from the user. Then the processor is configured to import an audio file, and record the audio file or convert textual information into the audio file through an audio module. The graphical image file plays the audio file upon receiving the interacting gesture from the user. Furthermore, the processor is configured to append at least one of a web link, a pop-up link, a conditional link, a share link, and/or a combination thereof through a link module. Then the processor is configured to append a plurality of payment receiving information corresponding to one or more items through a payment module.

The processor is further configured to provide the user with access to the interactive content on detecting a completion of a plurality of predefined parameters through an access module. The processor is then configured to provide the user with one or more rewards on detecting a completion of a plurality of predefined criteria through a reward module.

Accordingly, one advantage of the present invention is that it increases the efficiency and speed of producing multimedia content.

Accordingly, one advantage of the present invention is that it provides a cost-effective mechanism to create multimedia content.

Accordingly, one advantage of the present invention is that it can provide a larger range of hotspot types results which can be utilized in more innovative ways such as conditional prizes, locked content, sound hotspots, etc.

Other features of embodiments of the present disclosure will be apparent from accompanying drawings and from the detailed description that follows.

### BRIEF DESCRIPTION OF THE DRAWINGS

In the figures, similar components and/or features may have the same reference label. Further, various components of the same type may be distinguished by following the reference label with a second label that distinguishes among the similar components. If only the first reference label is used in the specification, the description applies to any one of the similar components having the same first reference label irrespective of the second reference label.

FIG. 1 illustrates a network implementation of the present system and method to integrate a plurality of interactive content, a plurality of interactive functions and a plurality of e-commerce features in a plurality of graphical image files, in accordance with an embodiment of the present subject matter.

FIG. 2 illustrates the present system to integrate a plurality of interactive content, a plurality of interactive functions and a plurality of e-commerce features in a plurality of graphical image files, in accordance with an embodiment of the present subject matter.

FIG. 3 illustrates a flowchart of the method for integrating a plurality of interactive content, a plurality of interactive functions and a plurality of e-commerce features in a plurality of graphical image files, in accordance with at least one embodiment.

FIG. 4 illustrates an operational view of the import module and editor module, in accordance with at least one embodiment.

FIG. 5 illustrates an operational view of the text module, in accordance with at least one embodiment.

FIG. 6 illustrates an operational view of the image module, in accordance with at least one embodiment.

FIG. 7 illustrates an operational view of the query module, in accordance with at least one embodiment.

FIG. 8 illustrates an operational view of the audio module, in accordance with at least one embodiment.

FIG. 9 illustrates an operational view of the link module, in accordance with at least one embodiment.

FIG. 10 illustrates an operational view of the payment module, in accordance with at least one embodiment.

FIG. 11 illustrates an exemplary view of the interactive content pertaining to education, in accordance with at least one embodiment.

FIG. 12 illustrates an exemplary view of the interactive content pertaining to advertising, in accordance with at least one embodiment.

FIG. 13 illustrates an exemplary view of the interactive content pertaining to a plurality of predefined conditions, in accordance with at least one embodiment.

FIG. 14 illustrates an operational view of the access module, in accordance with at least one embodiment.

FIG. 15 illustrates an operational view of the reward module, in accordance with at least one embodiment.

FIG. 16 illustrates an exemplary view of a plurality of hotspot images pertaining to teaching languages, in accordance with at least one embodiment.

FIG. 17 illustrates an operational flowchart of the plurality of conditional hotspots, in accordance with at least one embodiment.

FIG. 18 illustrates a functional view of the plurality of chain hotspots, in accordance with at least one embodiment.

### DETAILED DESCRIPTION

Systems and methods are disclosed for integrating a plurality of interactive content, a plurality of interactive functions and a plurality of e-commerce features in a plurality of graphical image files. Embodiments of the present disclosure include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, firmware, and/or by human operators.

Embodiments of the present disclosure may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more machine-readable storage media containing the code according to the present disclosure with appropriate standard computer hardware to execute the code contained therein. An apparatus for practicing various embodiments of the present disclosure may involve one or more computers (or one or more processors within a single computer) and storage systems containing or having network access to computer program(s) coded in accordance with various methods described herein, and the method steps of the disclosure could be accomplished by modules, routines, subroutines, or subparts of a computer program product.

Although the present disclosure has been described with the purpose of integrating a plurality of interactive content, a plurality of interactive functions and a plurality of e-commerce features in a plurality of graphical image files, it should be appreciated that the same has been done merely to illustrate the invention in an exemplary manner and any other purpose or function for which explained structures or configurations could be used, is covered within the scope of the present disclosure.

Exemplary embodiments will now be described more fully hereinafter with reference to the accompanying drawings, in which exemplary embodiments are shown. This invention may, however, be embodied in many different forms and should not be construed as limited to the embodiments set forth herein. These embodiments are provided so that this disclosure will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular name.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail to avoid obscuring the embodiments.

The term “machine-readable storage medium” or “computer-readable storage medium” includes, but is not limited to, portable or non-portable storage devices, optical storage devices, and various other mediums capable of storing, containing, or carrying instruction(s) and/or data. A machine-readable medium may include a non-transitory medium in which data can be stored, and that does not include carrier waves and/or transitory electronic signals propagating wirelessly or over wired connections. Examples of a non-transitory medium may include but are not limited to, a magnetic disk or tape, optical storage media such as compact disk (CD) or versatile digital disk (DVD), flash memory, memory or memory devices.

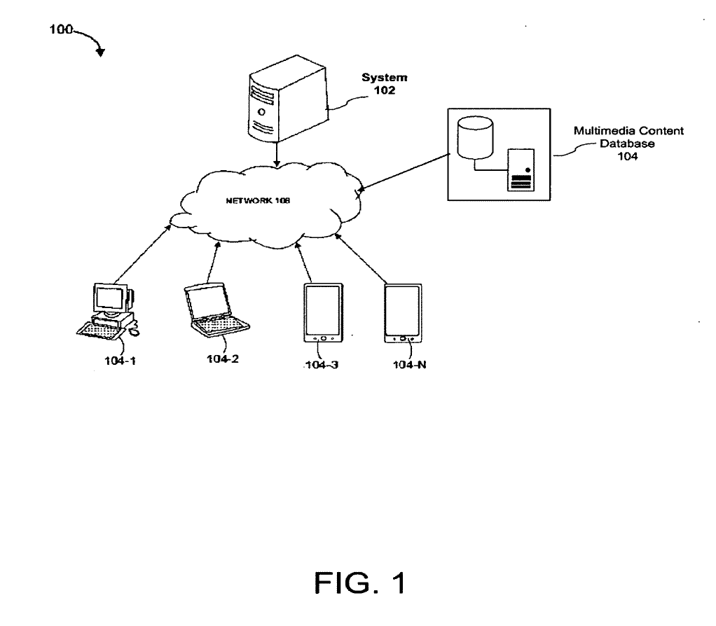

FIG. 1 illustrates a network implementation 100 of the present system and method to integrate a plurality of interactive content, a plurality of interactive functions and a plurality of e-commerce features in a plurality of graphical image files, in accordance with an embodiment of the present subject matter. Although the present subject matter is explained considering that the present system 102 is implemented on a server, it may be understood that the present system 102 may also be implemented in a variety of computing systems, such as a laptop computer, a desktop computer, a notebook, a workstation, a mainframe computer, a server, a network server, and the like. It will be understood that the present system 102 may be accessed by multiple users through one or more computing devices 104-1, 104-2 . . . 104-N, collectively referred to as computing unit 104 hereinafter, or applications residing on the computing unit 104. Examples of the computing unit 104 may include but are not limited to, a portable computer, a personal digital assistant, a handheld or mobile device, smart devices, and a workstation. The computing units 104 are communicatively accessible to the present system 102 through a network 106.

In one implementation, the network 106 may be a wireless network, a wired network or a combination thereof. The network 106 can be implemented as one of the different types of networks, such as an intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further, the network 106 may include a variety of network devices, including routers, bridges, servers, computing devices, storage devices, and the like.

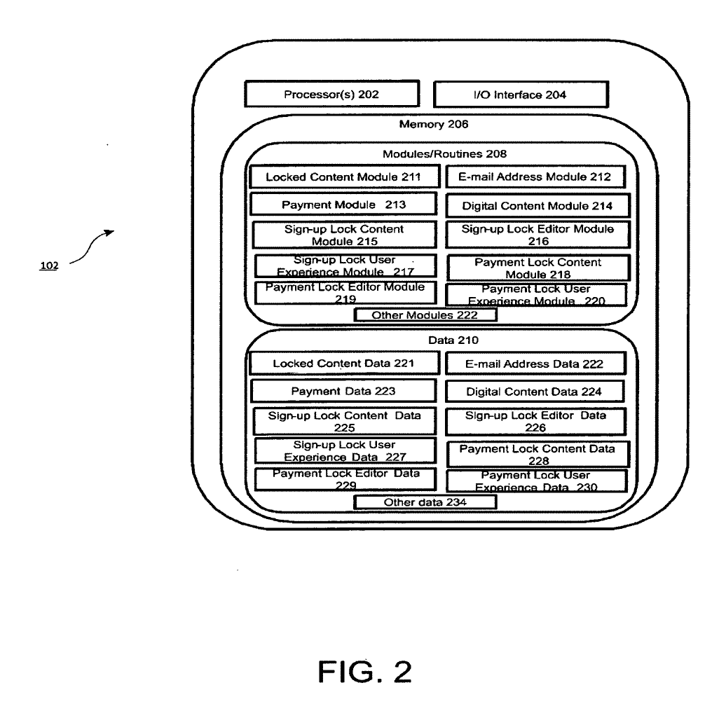

FIG. 2 illustrates the present system 102 to integrate a plurality of interactive content, a plurality of interactive functions and a plurality of e-commerce features in a plurality of graphical image files, in accordance with an embodiment of the present subject matter. The system 102 may include at least one processor 202, an input/output (I/O) interface 204, and a memory 206.

The processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to fetch and execute computer-readable instructions stored in the memory 206.

The I/O interface 204 may include a variety of software and hardware interfaces, for example, a web interface, a graphical user interface, and the like. The I/O interface 204 may allow the system 102 to interact with a user directly or through the computing unit 104. Further, the I/O interface 204 may enable the system 102 to communicate with other computing devices, such as web servers and external data servers (not shown). The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium known in the art including, for example, volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes. The memory 206 may include modules 208 and data 210.

The modules 208 include routines, programs, objects, components, data structures, etc., which perform particular tasks or implement particular abstract data types. In one implementation, the modules 208 may include an import module 211, an editor module 212, a hotspot type module 213, an access module 214, a reward module 215 and other module 224. The hotspot type module 213 comprises a text module 216, an image module 217, a query module 218, an audio module 219, a link module 220, and a payment module 221. The other modules 224 may include programs or coded instructions that supplement applications and functions of the system 102.

The data 210, amongst other things, serves as a repository for storing data processed, received, and generated by one or more of the modules 208. The data 210 may also include an import data 226, an editor data 227, a hotspot type data 228, an access data 229, a reward data 230 and other data 234. The hotspot type data 228 comprises a text data 231, an image data 232, a query data 233, an audio data 234, a link data 235, a payment data 236 and other data 238. The other data 238 may include data generated as a result of the execution of one or more modules in the other module 224.

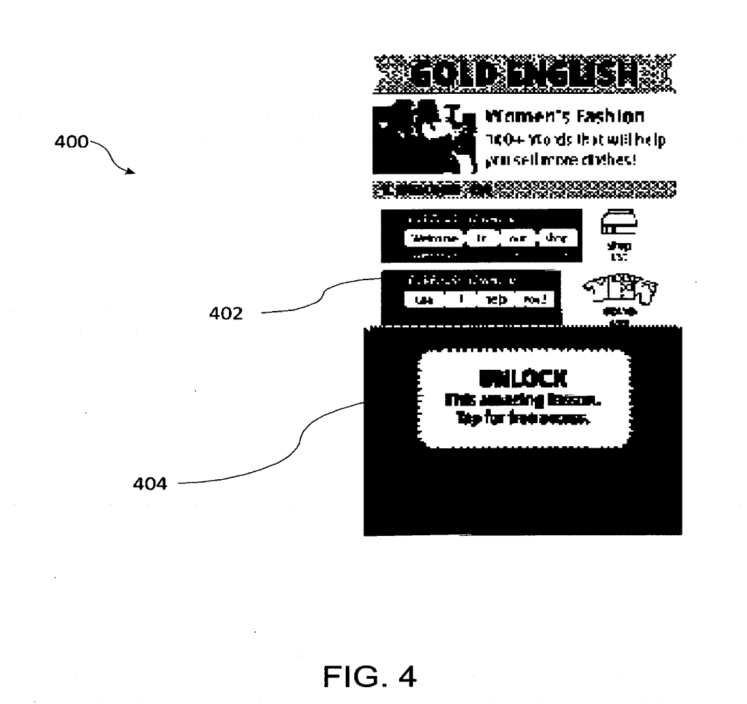

In one implementation, the import module 211 is configured to import a plurality of images file from a plurality of graphics applications. The editor module 212 is configured to receive the imported image files. The image file comprises a hotspot graphic 402 adaptable to receive a stretch command, a move command and a rotate command from a user. In an embodiment, the hotspot graphic 402 appears (shown in FIG. 4) on-receiving double-click or touch gesture from the user. FIG. 4 illustrates an operational view 400 of the import module 211 and editor module 212, in accordance with at least one embodiment. The user can stretch, move, and rotate the hotspot graphic 402 as per his/her requirement.

The hotspot type module 213 pops-up on receiving a click gesture from a user. Further, the hotspot type module 213 enables a user to append the plurality of interactive content, interactive functions, and e-commerce features into the imported image file to obtain the graphical image file. Further, the user can select from different hotspot types, styles, and behaviors.

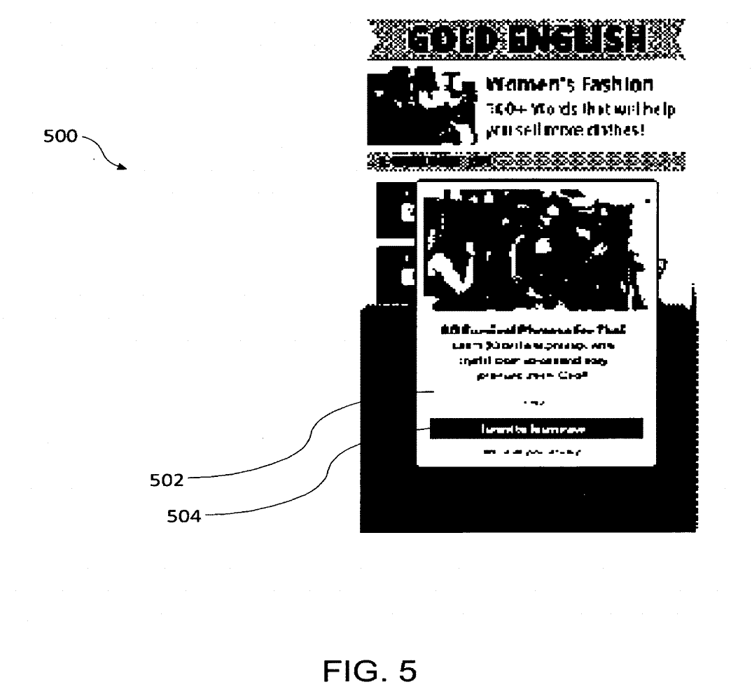

FIG. 5 illustrates an operational view 500 of the text module 216, in accordance with at least one embodiment. The text module 216 is configured to enable the user to feed a textual data corresponding to the image file. The graphical image file displays the textual data fed into the text module 216 on receiving an interacting gesture such as click or touch from the user.

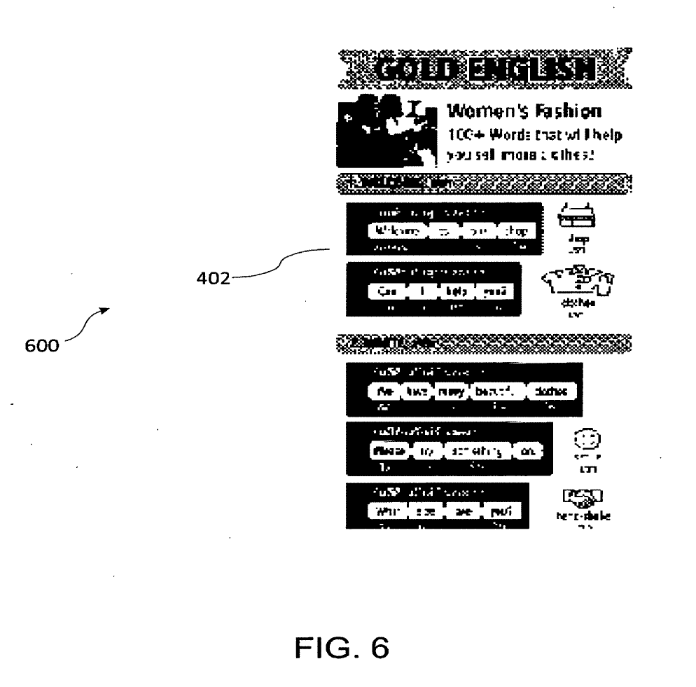

FIG. 6 illustrates an operational view 600 of the image module 217, in accordance with at least one embodiment. The image module 217 is configured to import a local image from a plurality of locations corresponding to the image file. Examples of the plurality of location include but not limited to the local drive of the computer, external websites, image servers, etc. The graphical image file displays the local image imported by the image module 217 on receiving the interacting gesture such as click or touch from the user.

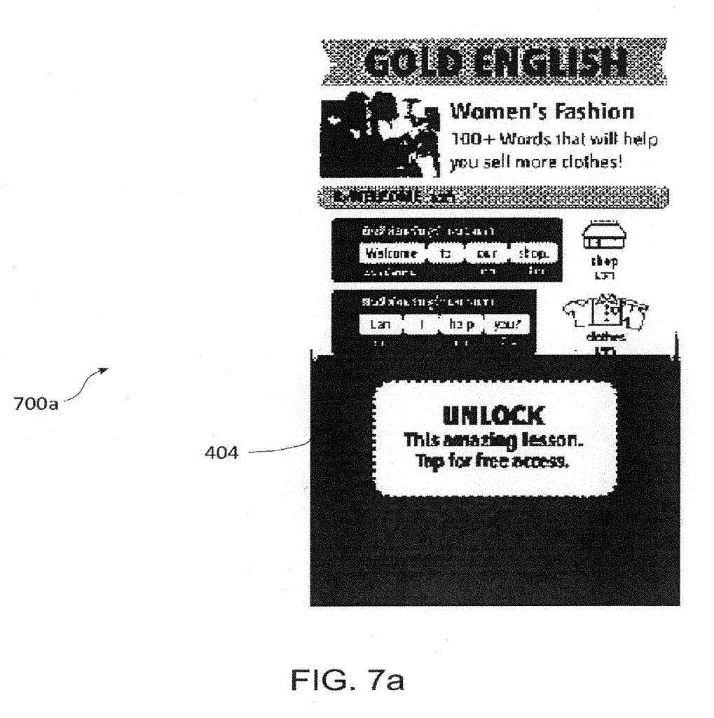

FIG. 7 illustrates an operational view 700 of the query module 218, in accordance with at least one embodiment. The query module 218 enables the user to append a plurality of multiple choice questions and further enables the user to import a plurality of answer images. The graphical image file displays the appended multiple choice questions and answer images on receiving the interacting gesture such as click or touch from the user.

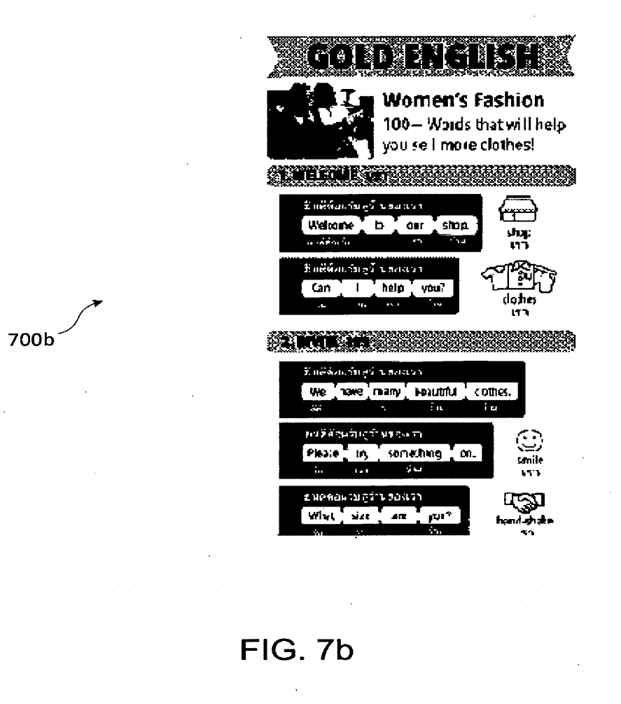

FIG. 8 illustrates an operational view 800 of the audio module 219, in accordance with at least one embodiment. The audio module 219 enables the user to import an audio file, and further enables the user to record the audio file or convert textual information into the audio file. The graphical image file plays the audio file upon receiving the interacting gesture such as click or touch from the user.

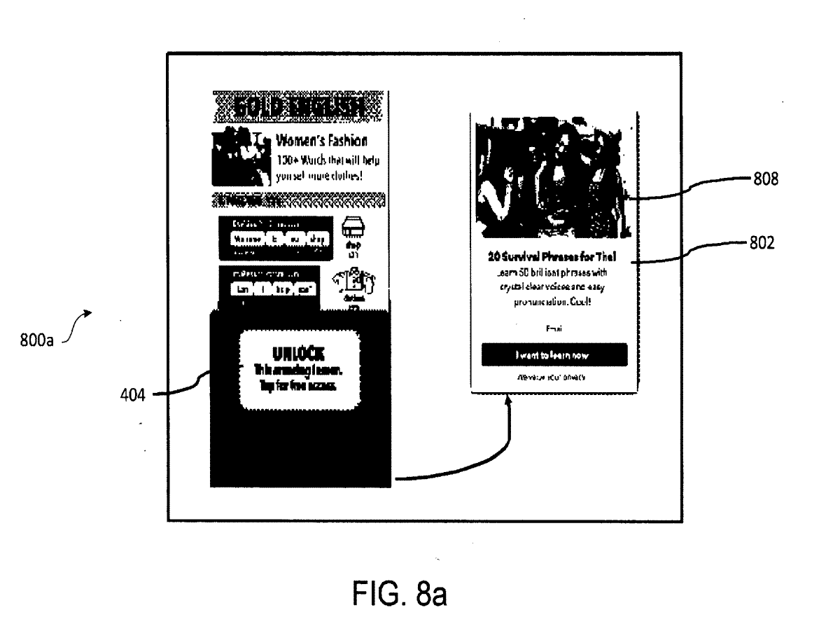

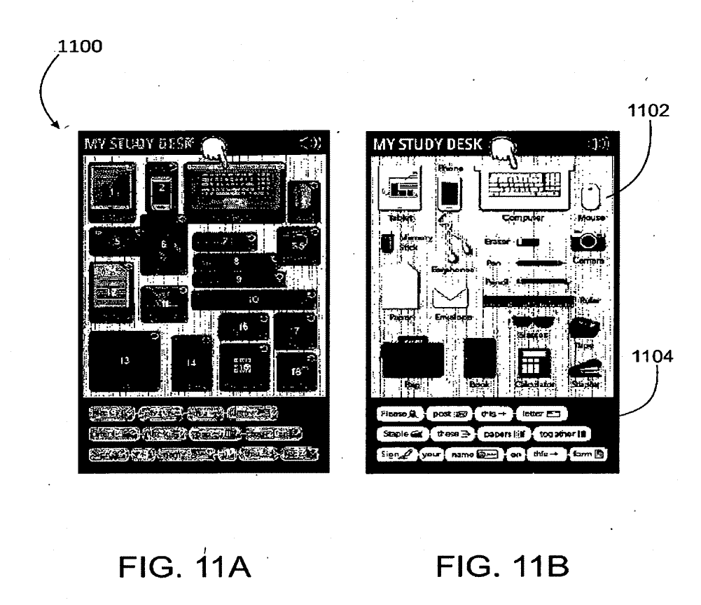

FIG. 9 illustrates an operational view 900 of the link module 220, in accordance with at least one embodiment. The link module 220 enables the user to append at least one of a web link, a pop-up link, a conditional link, and a share link. In an embodiment, the pop-up link displays a pop-up window having a predefined multimedia content. In an embodiment, the conditional link redirects to a predefined link on detecting a completion of a plurality of predefined conditions. FIG. 13 illustrates an exemplary view 1300 of the interactive content pertaining to a plurality of predefined conditions, in accordance with at least one embodiment. FIG. 13A illustrates the hotspot editor view of the interactive content pertaining to the plurality of predefined conditions. The exemplary view of the FIG. 13A shows how the conditional hotspot links can drive traffic to the specific advertisers. The conditional link hotspot 1302 enables the users to see the prize page if and only if they have clicked on Hotspots 1-9. FIG. 13A shows each hotspots 1-9 has a video or offer from a pub. Hotspot 9 acts as popup link hotspot. FIG. 13B illustrates the end user view of the interactive content which helps to drive traffic to the specific advertisers. Further, the user can also unlock the additional interactive content. For example, the user may get access to see lesson two if he/she has completed lesson 1 activities.

In an embodiment, the share link displays a plurality of social media icons in a pop-up window above the graphical image file. Examples of the social media icons include but not limited to Facebook, Twitter, LinkedIn, Instagram, WhatsApp, Gmail, etc. In an embodiment, the web link redirects the user to a website appended by the user.

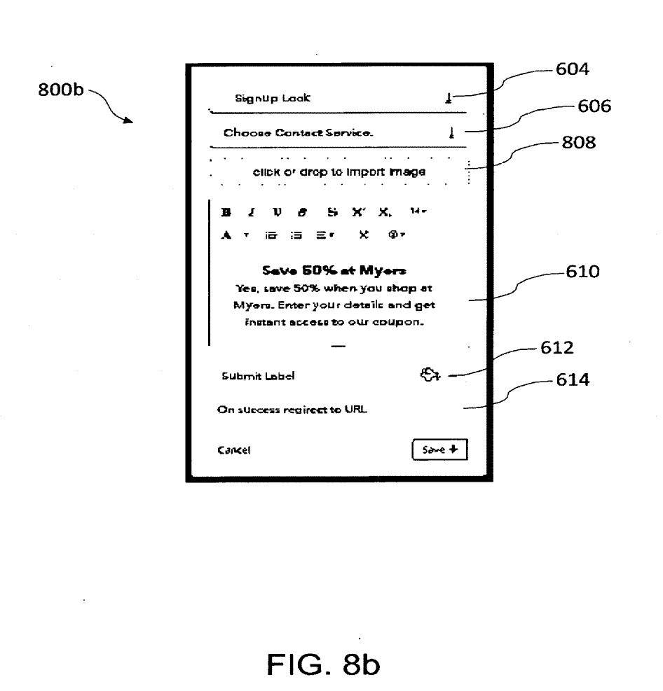

FIG. 10 illustrates an operational view 1000 of the payment module 221, in accordance with at least one embodiment. The payment module 221 enables the user to append a plurality of payment receiving information corresponding to one or more items. The payment module 221 enables a user to feed the payment information such as name, e-mail address, and credit card/debit card details in order to access the complete version of the interactive content such as multimedia or digital content. After receiving the payment from the user, the full version of the multimedia or digital content is displayed on the computing device of the user.

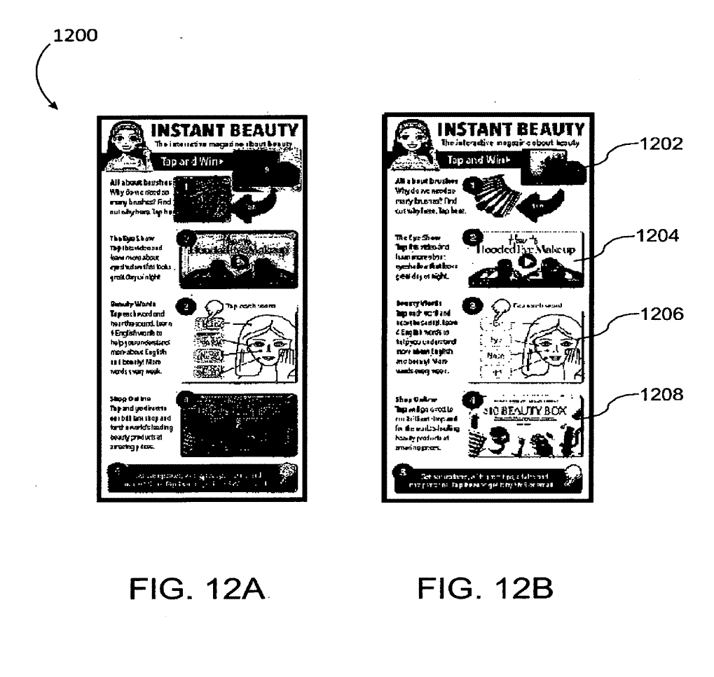

FIG. 14 illustrates an operational view 1400 of the access module 214, in accordance with at least one embodiment. The access module 214 allows the user to access the interactive content on detecting a completion of a plurality of predefined parameters. FIG. 14A illustrates the locked end-user view of the interactive content. The user has to click over 1402 and register or pay to access the locked interactive content. The user can see the locked content shaded in grey 1404 but cannot play or access the interactive content. FIG. 14b illustrates the unlocked end-user view of the interactive content. FIG. 14B can only be accessible to the user after he/she registers or pays for the access. The user has registered or paid and can access all the locked interactive content. Further, the users can win a prize 1406 if they click on all the hotspots on the image.

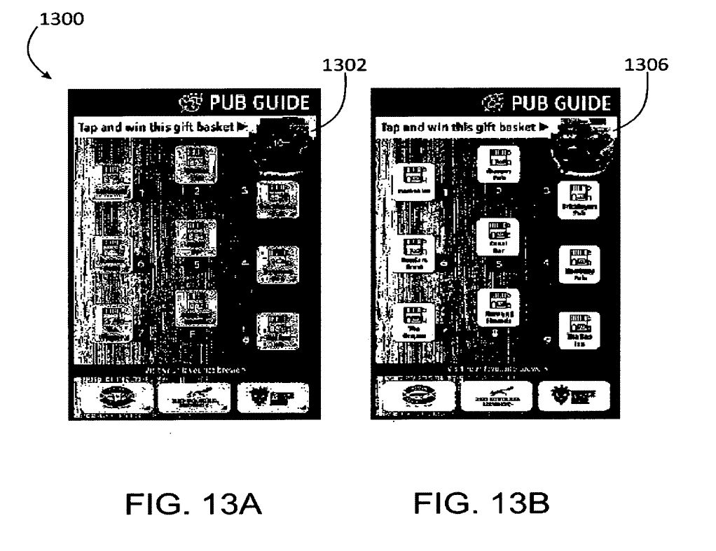

FIG. 15 illustrates an operational view 1500 of the reward module 215, in accordance with at least one embodiment. The reward module 215 provides the user with one or more rewards on detecting a completion of a plurality of predefined criteria. FIG. 15A illustrates that the specific hotspots can be predefined which contain a multiple choice question and must be answered correctly before a user is allowed access to a prize, reward or the next screen or lesson. For example, each animal hotspot has a question. A user such as a student can answer all the questions correctly and get access to the reward 1502. The user such as an editor or a back-end user can specify which hotspots (question hotspot 1504) must be answered correctly to access the prize or next screen. FIG. 15B illustrates the end user view of the interactive content. The end user must click on all hotspots specified by the editor, to be granted access to a prize or reward. Further, a predefined link 1506 by the editor provides access to a reward or prize, or next screen if the student has answered each hotspot question correctly.

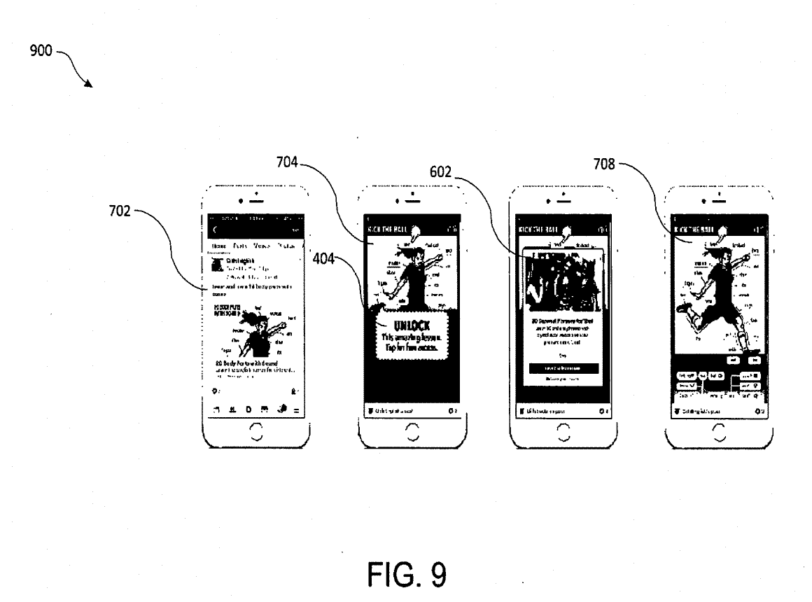

FIG. 11 illustrates an exemplary view 1100 of the interactive content pertaining to education, in accordance with at least one embodiment. FIG. 11A illustrates the editor view of the interactive content pertaining to education. Further, FIG. 11A shows how the hotspots can be used in innovative ways to teach. FIG. 11B illustrates the end user view of the interactive content pertaining to education. The users such as students can click/tap to play the interactive content. The user can click/tap on words 1102 to hear the sound. Further, the link sound hotspots together to form phrases 1104.

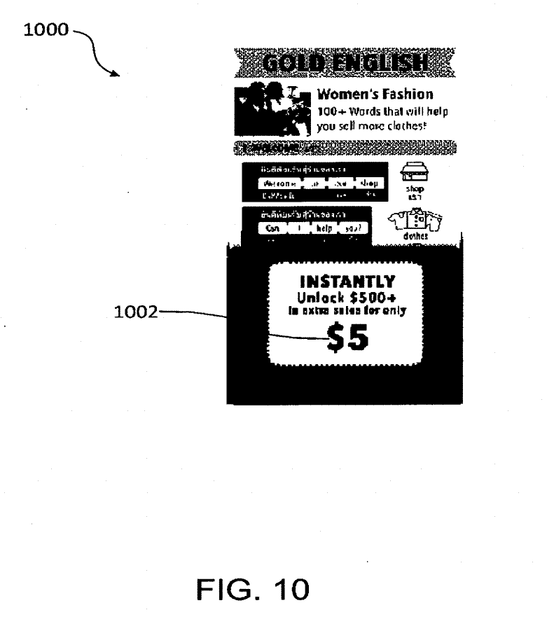

FIG. 12 illustrates an exemplary view 1200 of the interactive content pertaining to advertising, in accordance with at least one embodiment. FIG. 12A illustrates the editor view of the interactive content pertaining to advertising. FIG. 12A shows how multiple hotspot types can be used in innovative ways for advertisements. FIG. 12B illustrates the end user view of the interactive content pertaining to advertising. The conditional link hotspot 1202 enables the users to enter into a competition, if and only if they have clicked on all other hotspots. The popup link hotspot 1204 shows a Youtube video when clicked/touched. Further, the sound hotspot 1206 plays a recorded sound when clicked/touched. Then the popup link hotspot 1208 shows a subscription form when clicked/touched.

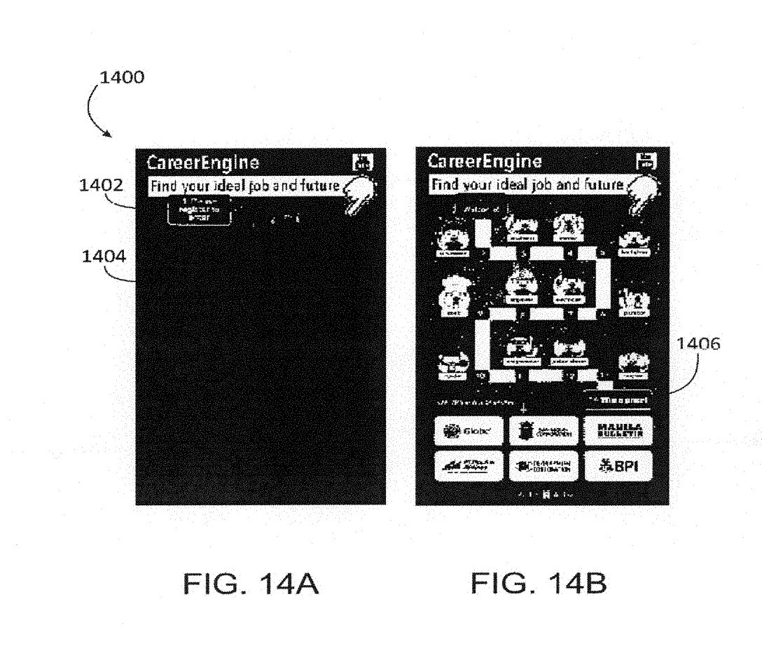

FIG. 16 illustrates an exemplary view 1600 of a plurality of hotspot images pertaining to teaching languages, in accordance with at least one embodiment. The user can add phrases to specific hotspots Type in text, and the present system converts it to a voice assigned by the user to a hotspot. For example, on hotspots#10 “Turn right here” (1602) (shown in FIG. 16A). The user may add words to specific hotspots type in text, and the present system converts it to a voice assigned to a hotspot. For example, “Intersection” (1604) (shown in FIG. 16A). Then the user may convert text to voice 1606 (shown in FIG. 16B) for hotspots. The user can type in the text and set gender, nationality, and speed of voice. The user gets the voice and assigns to a hotspot. In an embodiment, the converted text is a sound waveform which can be assigned to any hotspot.

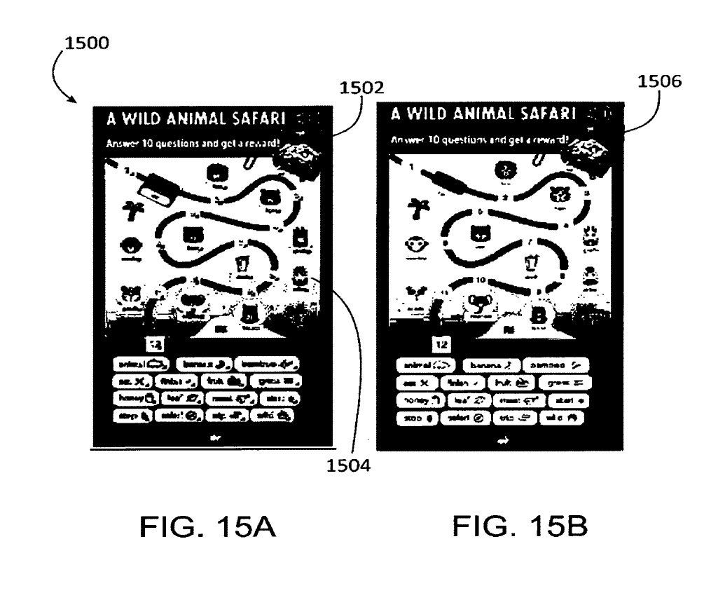

FIG. 17 illustrates an operational flowchart 1700 of the plurality of conditional hotspots, in accordance with at least one embodiment. The editor module 212 enables an editor to integrate a plurality of conditional hotspots and a plurality of rewards corresponding to the plurality of conditional hotspots. The editor may setup a conditional hotspot on an image such as ‘claim this reward’. When a user clicks on the hotspot, the conditional hotspot indicates the details of the reward and highlights the hotspots on the image which the user must click on. Further, the editor can specify what reward, content or action will be unlocked when the user has clicked on all required hotspots on the graphic.

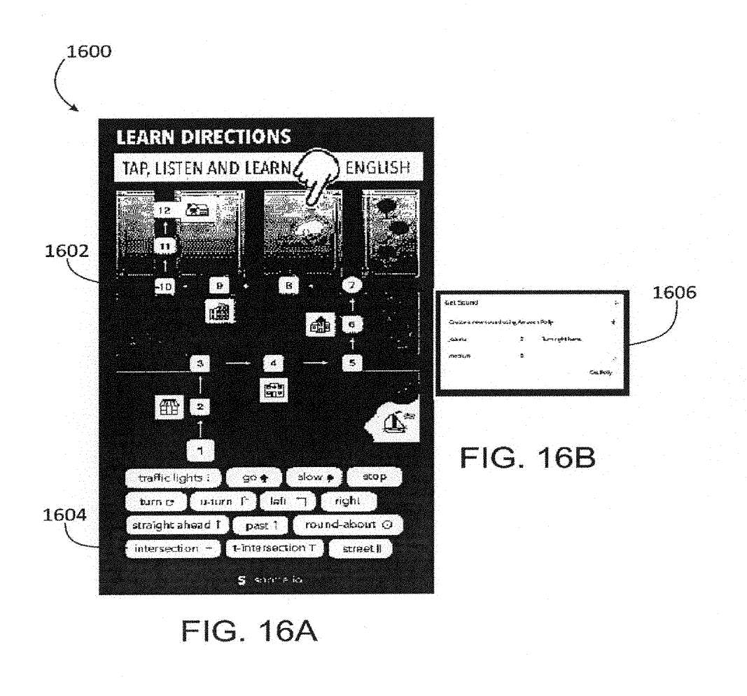

FIG. 18 illustrates a functional view 1800 of the plurality of chain hotspots, in accordance with at least one embodiment. The editor module 212 further enables an editor to create a plurality of chain hotspots 1802 by integrating the hotspot on the graphic in a chain of hotspots. In operation, the editor specifies which hotspots on the graphic will be in the chain of hotspots. Further, the editor can select one or more hotspots on the graphic. When a user clicks a chain hotspot button 1802a, each hotspot button in the chain plays a sound, or will be highlighted in sequence with graphics or sound.

Further, the language learners can click on each audio hotspot 1804 individually to hear a sound. Alternatively, the learners can also click a chain hotspot to play each audio hotspot in the chain. Further, the system may ask a user to identify any blue colors 1804a, and 1804b in a puzzle. Clicking a chain hotspot called ‘ANSWER’ plays each correct audio hotspot in the chain hotspot with animation or sound.

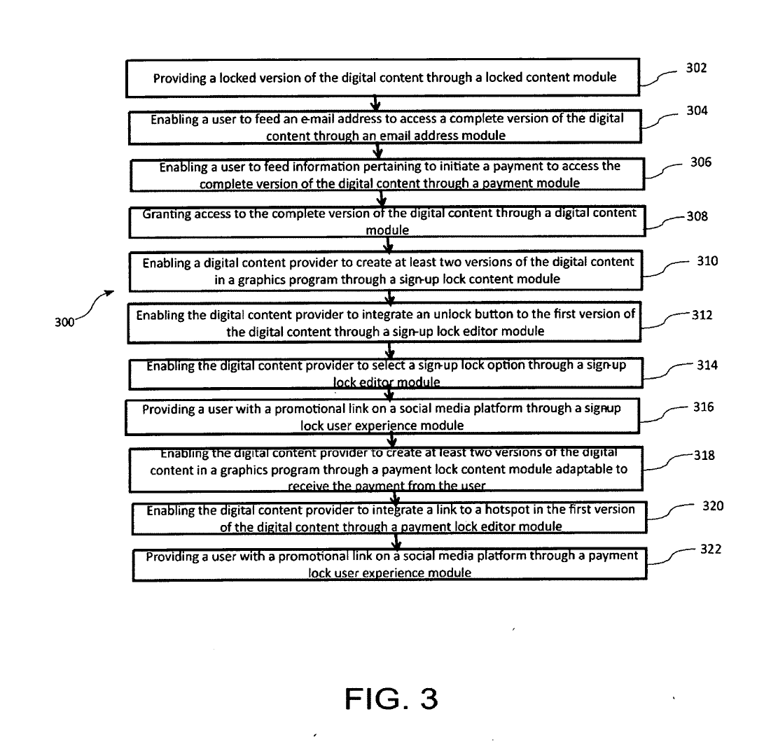

FIG. 3 illustrates a flowchart 300 of the method for integrating a plurality of interactive content, a plurality of interactive functions and a plurality of e-commerce features in a plurality of graphical image files, in accordance with at least one embodiment. The method initiates with a step 302 of importing a plurality of images file from a plurality of graphics applications through an import module. The method then includes the step 304 of receiving the imported image files through an editor module. The image file comprises a hotspot graphic adaptable to receive a stretch command, a move command and a rotate command from a user. Further, the method includes the step 306 of popping a hotspot type module on receiving a click gesture from a user. The hotspot type module enables a user to append the plurality of interactive content, interactive functions, and e-commerce features into the imported image file to obtain the graphical image file.

Then the method includes the step 308 of feeding a textual data corresponding to the image file through a text module configured in the hotspot type module. The graphical image file displays the textual data fed into the text module on receiving an interacting gesture from the user. The method then includes the step 310 of importing a local image from a plurality of locations corresponding to the image file through an image module configured in the hotspot type module. The graphical image file displays the local image imported by the image module on receiving the interacting gesture from the user. Then the method includes the step 312 of appending a plurality of multiple choice questions and further enabling the user to import a plurality of answer images through a query module configured in the hotspot type module. The graphical image file displays the appended multiple choice questions and answer images on receiving the interacting gesture from the user.

Furthermore, the method includes the step 314 of importing an audio file and further enabling the user to record the audio file or convert textual information into the audio file through an audio module configured in the hotspot type module. The graphical image file plays the audio file upon receiving the interacting gesture from the user. The method then includes the step 316 of appending at least one of a web link, a pop-up link, a conditional link, and a share link through a link module configured in the hotspot type module. The method then includes the step of 318 appending a plurality of payment receiving information corresponding to one or more items through a payment module configured in the hotspot type module. The method further comprises a step 320 of allowing the user to access the interactive content on detecting a completion of a plurality of predefined parameters through an access module. The method then comprises a step 322 of providing the user with one or more rewards on detecting a completion of a plurality of predefined criteria through a reward module.

Thus the present system and method provide an efficient, simpler and more elegant framework to create and edit hotspot images and provide an easier way to share over the Internet. Further, the present system and method provide a novel way in which the hotspot images can be used for education, language training, advertising and digital marketing.

While embodiments of the present disclosure have been illustrated and described, it will be clear that the disclosure is not limited to these embodiments only. Numerous modifications, changes, variations, substitutions, and equivalents will be apparent to those skilled in the art, without departing from the scope of the disclosure, as described in the claims.

1. A device in a network, comprising:
a non-transitory storage device having embodied therein one or more routines operable to integrate a plurality of interactive content, a plurality of interactive functions and a plurality of e-commerce features in a plurality of graphical image files; and
one or more processors coupled to the non-transitory storage device and operable to execute the one or more routines, wherein the one or more routines include:
an import module to import a plurality of images file from a plurality of graphics applications;
an editor module to receive the imported image files, wherein the image file comprises a hotspot graphic adaptable to receive a stretch command, a move command and a rotate command from a user; and
a hotspot type module pops-up on receiving a click gesture from a user, wherein the hotspot type module enables a user to append the plurality of interactive content, interactive functions, and e-commerce features into the imported image file to obtain the graphical image file, the hotspot type module comprises:
a text module to enable the user to feed a textual data corresponding to the image file, wherein the graphical image file displays the textual data fed into the text module on receiving an interacting gesture from the user;
an image module to import a local image from a plurality of locations corresponding to the image file, wherein the graphical image file displays the local image imported by the image module on receiving the interacting gesture from the user;
a query module enables the user to append a plurality of multiple choice questions and further enables the user to import a plurality of answer images, wherein the graphical image file displays the appended multiple choice questions and answer images on receiving the interacting gesture from the user;
an audio module enables the user to import an audio file, and further enables the user to record the audio file or convert textual information into the audio file, wherein the graphical image file plays the audio file on receiving the interacting gesture from the user;
a link module enables the user to append at least one of a web link, a pop-up link, a conditional link, a share link, and/or a combination thereof; and
a payment module enables the user to append a plurality of payment receiving information corresponding to one or more items.

2. The device according to claim 1, further comprises an access module allows the user to access the interactive content on detecting a completion of a plurality of predefined parameters.

3. The device according to claim 1, further comprises a reward module provides the user with one or more rewards on detecting a completion of a plurality of predefined criteria.

4. The device according to claim 1, wherein the editor module enables an editor to integrate a plurality of conditional hotspots and a plurality of rewards corresponding to the plurality of conditional hotspots.

5. The device according to claim 1, wherein the editor module further enables an editor to create a plurality of chain hotspots by integrating a hotspot in a chain of hotspots.

6. The device according to claim 1, wherein the web link redirects the user to a website appended by the user.

7. The device according to claim 1, wherein the pop-up link displays a pop-up window having a predefined multimedia content.

8. The device according to claim 1, wherein the conditional link redirect to a predefined link on detecting a completion of a plurality of predefined conditions.

9. The device according to claim 1, wherein the share link displays a plurality of social media icons in a pop-up window above the graphical image file.

10. A method implemented by one or more processors for integrating a plurality of interactive content, a plurality of interactive functions and a plurality of e-commerce features in a plurality of graphical image files, the method comprising steps of:
importing, by one or more processors, a plurality of images file from a plurality of graphics applications through an import module;
receiving, by one or more processors, the imported image files through an editor module, wherein the image file comprises a hotspot graphic adaptable to receive a stretch command, a move command and a rotate command from a user;
popping, by one or more processors, a hotspot type module on receiving a click gesture from a user, wherein the hotspot type module enables a user to append the plurality of interactive content, interactive functions, and e-commerce features into the imported image file to obtain the graphical image file;
feeding, by one or more processors, a textual data corresponding to the image file through a text module configured in the hotspot type module, wherein the graphical image file displays the textual data fed into the text module on receiving an interacting gesture from the user;
importing, by one or more processors, a local image from a plurality of locations corresponding to the image file through an image module configured in the hotspot type module, wherein the graphical image file displays the local image imported by the image module on receiving the interacting gesture from the user;
appending, by one or more processors, a plurality of multiple choice questions and further enabling the user to import a plurality of answer images through a query module configured in the hotspot type module, wherein the graphical image file displays the appended multiple choice questions and answer images on receiving the interacting gesture from the user;
importing, by one or more processors, an audio file, and further enabling the user to record the audio file or convert textual information into the audio file through an audio module configured in the hotspot type module, wherein the graphical image file plays the audio file on receiving the interacting gesture from the user;
appending, by one or more processors, at least one of a web link, a pop-up link, a conditional link, a share link, and/or a combination thereof through a link module configured in the hotspot type module; and
appending, by one or more processors, a plurality of payment receiving information corresponding to one or more items through a payment module configured in the hotspot type module.

11. The method according to claim 10, further comprises a step of allowing the user, by one or more processors, to access the interactive content on detecting a completion of a plurality of predefined parameters through an access module.

12. The method according to claim 10, further comprises a step of providing the user, by one or more processors, with one or more rewards on detecting a completion of a plurality of predefined criteria through a reward module.

13. The method according to claim 10, wherein the web link redirects the user to a website appended by the user.

14. The method according to claim 10, wherein the pop-up link displays a pop-up window having a predefined multimedia content.

15. The method according to claim 10, wherein the conditional link redirect to a predefined link on detecting a completion of a plurality of predefined conditions.

16. The method according to claim 10, wherein the share link displays a plurality of social media icons in a pop-up window above the graphical image file.

17. A system to integrate a plurality of interactive content, a plurality of interactive functions and a plurality of e-commerce features in a plurality of graphical image files, the system comprises:
a processor; and
a memory to store machine readable instructions that when executed by the processor cause the processor to:
import a plurality of images file from a plurality of graphics applications through an import module;
receive the imported image files through an editor module, wherein the image file comprises a hotspot graphic adaptable to receive a stretch command, a move command and a rotate command from a user; and
pop-up a hotspot type module on receiving a click gesture from a user, wherein the hotspot type module enables a user to append the plurality of interactive content, interactive functions, and e-commerce features into the imported image file to obtain the graphical image file;
feed a textual data corresponding to the image file through a text module, wherein the graphical image file displays the textual data fed into the text module on receiving an interacting gesture from the user;
import a local image from a plurality of locations corresponding to the image file through an image module, wherein the graphical image file displays the local image imported by the image module on receiving the interacting gesture from the user;
append a plurality of multiple choice questions and further enables the user to import a plurality of answer images through a query module, wherein the graphical image file displays the appended multiple choice questions and answer images on receiving the interacting gesture from the user;
import an audio file, and record the audio file or convert textual information into the audio file through an audio module, wherein the graphical image file plays the audio file on receiving the interacting gesture from the user;
append at least one of a web link, a pop-up link, a conditional link, a share link, and/or a combination thereof through a link module; and
append a plurality of payment receiving information corresponding to one or more items through a payment module.

18. The system according to claim 17, wherein the processor is further configured to provide the user with access to the interactive content on detecting a completion of a plurality of predefined parameters through an access module.

19. The system according to claim 17, wherein the processor is further configured to provide the user with one or more rewards on detecting a completion of a plurality of predefined criteria through a reward module.

20. The system according to claim 17, wherein the editor module enables an editor to integrate a plurality of conditional hotspots and a plurality of rewards corresponding to the plurality of conditional hotspots.

21. The system according to claim 17, wherein the editor module further enables an editor to create a plurality of chain hotspots by integrating a hotspot in a chain of hotspots.

22. The system according to claim 17, wherein the web link redirects the user to a website appended by the user.

23. The system according to claim 17, wherein the pop-up link displays a pop-up window having a predefined multimedia content.

24. The system according to claim 17, wherein the conditional link redirect to a predefined link on detecting a completion of a plurality of predefined conditions.

25. The system according to claim 17, wherein the share link displays a plurality of social media icons in a pop-up window above the graphical image file.
